(19) United States
(12) Patent Application Publication
(10) Pub. No.: US 2016/0027138 A1
(43) Pub. Date: Jan. 28, 2016

(54) Automated Patient Flow Management Systems

(71) Applicant: Epic Systems Corporation, Verona, WI (US)

(72) Inventor: Steven J. Larsen, Cross Plains, WI (US)

(21) Appl. No.: 14/874,933

(22) Filed: Oct. 5, 2015

Related U.S. Application Data
(63) Continuation-in-part of application No. 12/118,132, filed on May 9, 2008.
Application No. 12/118,132 is a continuation-in-part of application No. 14/290,616, filed on May 29, 2014.
Application No. 14/290,616 is a continuation of application No. 11/786,572, filed on Apr. 12, 2007, now Pat. No. 8,768,720.

(51) Int. Cl. G06Q 50/22; G06F 19/00; G06F 21/31

(52) U.S. Cl. CPC G06Q 50/22; G06F 21/31; G06F 19/327; G06F 19/322

(57) ABSTRACT

A patient flow management system includes a means for identifying a patient as the patient approaches an examination area. When the patient is identified, a patient encounter screen, which provides both patient data and medical procedure data, is provided in the examination area, thereby decreasing the need for paper charts and increasing the efficiency of the facility. The system can also include a timer for determining an amount of time that a patient has been left in an examination room, and kiosks for checking into an appointment and providing identifying tokens to the patient. The kiosks can identify whether a patient is in an appropriate location for check in, and guide the patient to an appropriate location.

### CROSS-REFERENCE TO RELATED APPLICATIONS

This application is a continuation-in-part of U.S. patent application Ser. No. 12/118,132 filed on May 9, 2008, and is also a continuation-in-part of U.S. patent application Ser. No. 14/290,616 filed on May 29, 2014, which is a continuation of U.S. patent application Ser. No. 11/786,572 filed on Apr. 12, 2007, now U.S. Pat. No. 8,768,720, each of which is hereby incorporated by reference in its entirety.

### STATEMENT REGARDING FEDERALLY SPONSORED RESEARCH OR DEVELOPMENT

Not applicable.

### BACKGROUND OF THE INVENTION

The present invention relates to automated check in systems for use by patients or clients to access health care related self-service options and more specifically to a system where distinct subsets of self-service options are to be provided at different kiosks and where each system kiosk is aware of which options are to be provided at different kiosks and is capable of providing guidance for patients that attempt to perform an activity at incorrect interface devices or kiosks. These systems can be used in conjunction with patient identifiers to automate patient throughput in a healthcare facility, and more particularly to a method for automating patient services in an examination area.

When a patient registers or checks-in to a health care facility, the patient typically meets with a receptionist. The receptionist queries the patient for appointment data, acquires insurance information, verifies the identity of the patient, prompts the patient to provide any necessary forms, and registers the patient for the appointment. After check-in, the patient is typically led to a check-in or waiting area until called for the appointment. When medical personnel are ready for the patient, a nurse typically leads the patient to an examination area, and provides an initial screening, questioning the patient about the reason for the visit. The nurse can also, at this time, acquire initial vital statistic data, such as the blood pressure and weight of the patient. All of this data is then typically entered into a patient chart by the nurse. The chart can be a paper document, and the data entry can be manual. Alternatively, the data can be entered into a computer system by the nurse. In either case, after this initial screening, the patient is typically left in the examination area until the assigned physician is free to see the patient.

Once in the examination area, the patient can be left for significant periods of time, depending on the schedule of the physicians. When the assigned medical personnel arrives, the patient typically is required to repeat the information that was given to the nurse, to allow medical personnel to verify that the appropriate chart has been associated with the patient, and to establish what procedures are appropriate for the patient. In the case of computerized medical records, this step is particularly critical, since when many patient records are available to medical personnel, a patient can be relatively easily mistaken for another patient, particularly when the patients have similar or identical names. When such errors are made, critical data, such as allergy data, can be missed. Failure to access the appropriate data can lead to serious medical errors.

The examination process in a medical facility, therefore, is typically manual in nature, requires significant personnel resources, and time-consuming cross-checking of data. As a result, checking in, tracking, and setting up patients to receive the appropriate medical care can be slow, inefficient, and error-prone. These problems, moreover, are exacerbated for patients that require multiple appointments or procedures scheduled in a single day.

Patients, therefore, commonly complain about a lack of correlation between scheduled appointment time and actual appointment time; about the need to repetitively explain the reason for their visit; and about the overall time spent simply waiting in medical facilities. Because of these complaints, patients can be discouraged from making medical appointments for anything short of an emergency, and not infrequently become frustrated and leave medical facilities without having seen a doctor. Furthermore, physicians often waste valuable time shuffling charts and other documents to align the patients that they find in examination rooms with the corresponding documents.

The present invention addresses these issues.

### SUMMARY OF THE INVENTION

It has been recognized that the patient confusion and missed or delayed appointments that can result from self check in systems can be avoided by limiting patient directed automated capabilities as a function of location, and further by making check in systems aware of their location relative to each other and to the locations where specific services are provided in the facility. To this end, according to one aspect of the present invention, in cases where check in systems are located at many different locations within a facility or on a campus and where each check in system is proximate one or a small number of departments, it is contemplated that each check in system may be programmed such that the system can only be used to check in patients for appointments at proximate departments. Here, where a patient attempts to check in at a system that is remote from his appointment, a warning is provided that the system cannot be used to check in for the appointment and, in at least some cases, instructions are provided that identify a facility and/or campus location at which the patient may check in for his appointment. In some cases directions are provided to a patient to guide the patient to an appropriate check in location.

In one aspect, the present invention provides a method for automating patient encounters in a health care facility comprising the steps of associating a patient identifier with a patient at the health care facility, reading the patient identifier when the patient enters an examination area using the patient identifier to access patient data in a database, and using the patient data to prepare for a patient encounter in the examination area.

In another aspect of the invention, the method further comprises retrieving a patient medical order from the database, and using the patient work order to prepare for the patient encounter. A medical device is controlled during the patient encounter based on data in the patient medical order.

In yet another aspect of the invention, a patient flow management system is provided. The patient flow management system includes a central computing system, a database in communication with the central computing system and storing patient identification data, appointment data, and medical order data, and a plurality of reader devices in communication with the central computing system. The reader devices are correlated with a plurality of examination areas and are programmed to read a patient identifier associated with a patient. When a patient enters a selected examination area, the reader reads the patient identifier, the central computer system retrieves data from the patient database based on the patient identifier, and prepares a medical encounter for medical personnel in the examination area based on the patient identifier.

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention can be employed. Other aspects, advantages and novel features of the invention will become apparent from the following detailed description of the invention when considered in conjunction with the drawings.

### BRIEF DESCRIPTION OF THE DRAWINGS

FIG. 1 is a schematic illustration illustrating a patient check in and integrated examination area management system constructed in accordance with the present invention;

FIG. 1A is a schematic illustration of a database providing patient information in a medical records database;

FIG. 1B is a schematic illustration of a database providing patient appointment data in a medical records database;

FIG. 1C is a schematic illustration of a database providing medical order data in a medical records database;

FIG. 1D is a schematic illustration illustrating a patient check in an alternate or additional management system constructed in accordance with the present invention;

FIG. 2 is a flow chart illustrating a process for checking in and retrieving a patient identifying token using the system of FIG. 1;

FIG. 3 is a screen shot illustrating entry into the check in system of FIG. 1,

FIG. 4 is a screen shot illustrating additional check-in steps for the system of FIG. 1;

FIG. 5 is a screen shot indicating patient identification and verification during check in;

FIG. 6 is a screen shot illustrating checking in for an appointment;

FIG. 7 is a screen shot illustrating additional steps for checking into an appointment;

FIG. 8 is a screen shot illustrating verification of check-in;

FIG. 9 is a screen shot prompting a user to retrieve a patient identifying token;

FIG. 10 is a top view of an examination area employing an examination area management system of FIG. 1;

FIG. 11 is a screen shot illustrating a screen for receiving a patient identifying token at an examination area;

FIG. 12 is a flow chart illustrating a timing process for determining a length of time that the patient has been in an examination area;

FIG. 13 is a screen shot illustrating data provided outside of the examination area while a patient is in the examination area;

FIG. 14 is a screen shot illustrating an over time condition on the screen outside of the examination area;

FIG. 15 is a flow chart illustrating a process for providing patient encounter data on the display inside of an examination area;

FIG. 16 is a screen shot illustrating a login screen for medical personnel;

FIG. 17 is a screen shot illustrating patient encounter data provided on the screen inside of the examination area;

FIG. 18 is an alternate screen shot illustrating patient encounter data provided on the screen inside of the examination area;

FIG. 19 is a schematic illustration of an examination area including a medical device and specifically an MRI scanner;

FIG. 20 is a screen shot illustrating an exemplary screen for the terminal in the examination area of FIG. 19; and

FIG. 21 is an screen shot illustrating an alternate exemplary screen for a terminal in the examination area of FIG. 19.

### DETAILED DESCRIPTION OF THE INVENTION

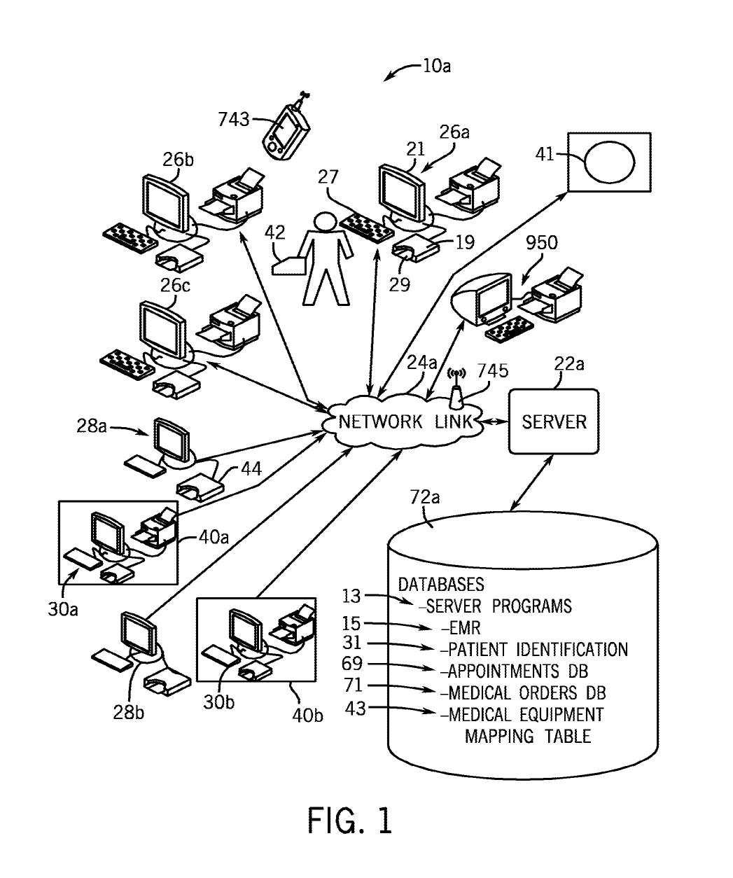

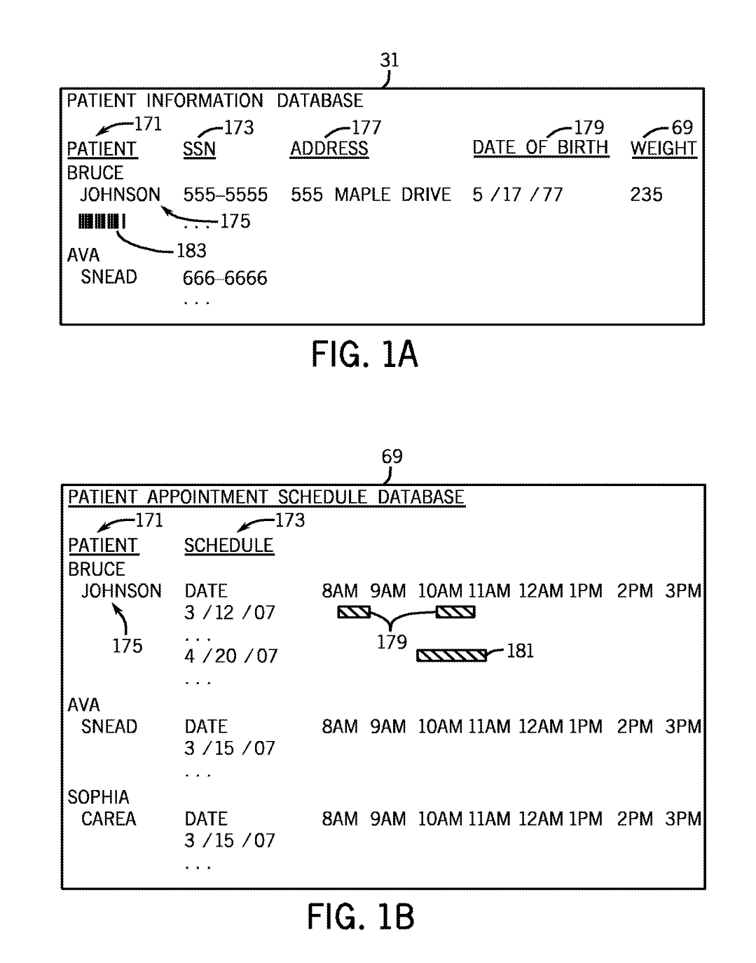

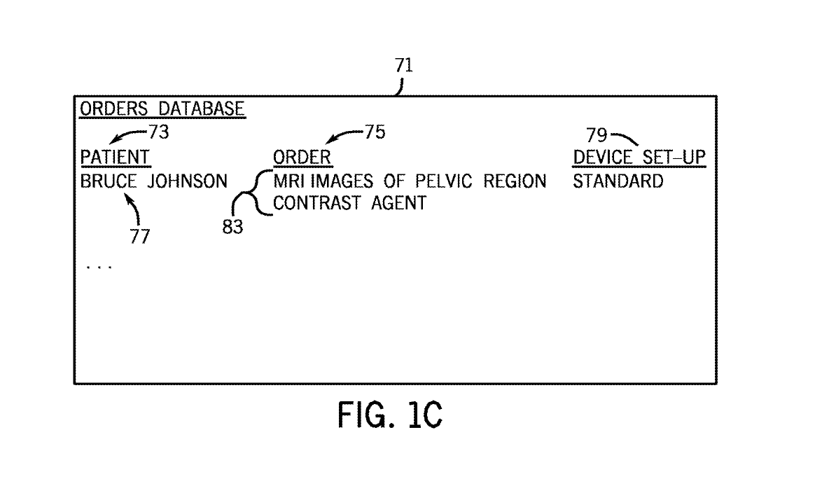

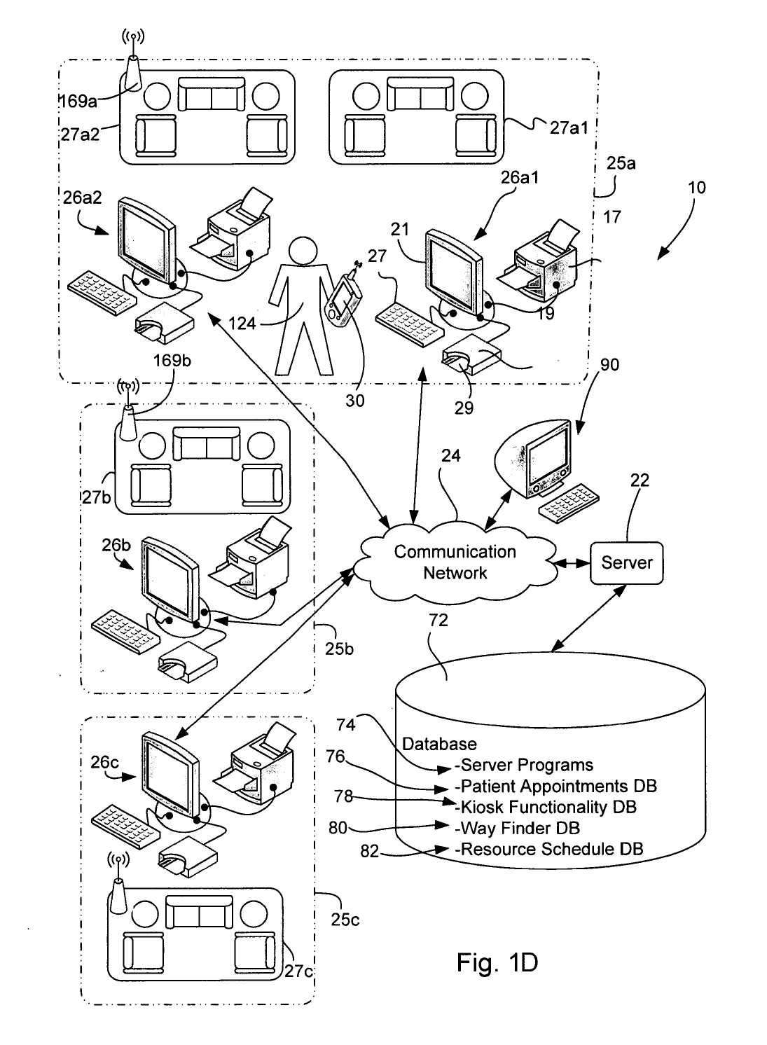

Referring now to the figures, and more particularly to FIG. 1, an exemplary patient flow management system 10a constructed in accordance with the present invention is shown. The flow management system 10a includes a plurality of external and internal examination area terminals 28a, 28b and 30a, 30b, respectively that are distributed both outside of and inside of examination areas 40a and 40b. Upon entry to the medical facility, the patient is provided with a readable token 42, as described more fully below, which can be used to track the patient through his or her appointments, and to set up patient encounters in examination areas 40a and 40b for the specific patient. The terminals 28a, 28b, 30a and 30b therefore provide automated tracking of the patient as the patient enters and exits examination areas 40a and 40b, and provide patient-specific data to the medical personnel while in the examination area. As used herein, the terms “patient encounter” and “patient encounter data” mean patient associated data and medical data and instructions required to complete a specific medical service for or examination of a patient.

As described below, a kiosk system comprising a plurality of kiosks 26a, 26b, and 26c can be provided to allow for automated check in into a medical facility, and for distribution of readable tokens 42. However, patients can also check into the facility through a home or other computer providing a virtual kiosk interface, through personal communication devices, or through traditional methods such as by registering with a receptionist or other medical personnel. Although the system is described below as including a kiosk system, it will therefore be apparent that this description is not intended to limit the scope of the invention, and that the registration process and token distribution can be provided in any of a number of different ways.

Referring still to FIG. 1, in addition to a plurality of patient kiosks 26a, 26b, and 26c and internal and external examination area terminals 28a, 28b and 30a, 30b, the flow management system 10a includes a server 22a, a database 72a, and a network 24a (e.g., a local area network, a wide area network, the Internet, etc.) which can include a wireless access point 745. As shown, medical equipment, such as MRI 41 can also be connected to the network link 24a. Server 22a runs software programs that perform various processes that are contemplated by the present invention, provides browser type screen shots to the kiosks and terminals 26a, 26b, 30a, 30b, etc.; receives input from the kiosks and terminals; and provides control commands to medical equipment such as the MRI 41 by correlating necessary functions with API, HL7, custom code, or other interfaces through a mapping table 43. In addition, server 22a and the kiosks and terminals can communicate with wireless handheld devices 743. These devices can be used by patients as part of the check-in process, or to notify medical personnel of patient delays, as described below. Although an MRI device is shown here, it will be apparent that any number of software-driven medical devices can be used in the system including, for example, drug delivery systems; imaging devices such as X-ray machines and CT scanners; and various types of monitors.

Each of kiosks and terminals 26a, 26b, 28a, 28b, 30a, and 30b may take any of several different forms including work stations, personal computers, laptops, thin-client type devices, etc. Where the kiosks and terminal devices are more than thin clients, in at least some embodiments each of these devices may perform all or at least a subset of the steps required to perform the inventive processes. When the kiosks and terminals are thin client type devices, each device operates primarily as a human-server interface device for input/output between a user and server 22a where server 22a performs most or all of the inventive process steps. Hereinafter, unless indicated otherwise and in the interest of simplifying this explanation, it will be assumed that each device 26a, 26b, 28a, 28b, 30a, 30b, etc., is a thin client type device.

Each of the kiosks 26a, 26b, etc., is similarly constructed and operates in a similar fashion and therefore, in the interest of simplifying this explanation, only kiosk 26a will be described here in any detail. Kiosk 26a includes a display 21, an input device 27, a card reader 19 and a printer 17. Input device 27 is shown as a keyboard but may be or include other input devices such as a touch screen, a mouse device, a track ball device, etc., and, is generally provided for, as the label implies, entering information into system 10a for use by server 22a. In the present case it will be assumed that the input device(s) 27 includes a keyboard for entering text type information and a mouse type device (not illustrated) for moving a mouse controlled cursor around on the screen of display 21. The printer 17 can be a paper printer, or specialized printer or equipment for producing RFID tags, bar codes, magnetic cards, smart cards or other specialized identifiers or both. In addition to providing paper print-out instructions for the patient, the printer 17 therefore can also provide patient tokens 42 for use in tracking the patient. The tokens 42 can be provided in cards or other devices carried by the patient, or can be provided on a wrist band, name tag, or other device that is worn by the patient, or that can be attached to the patient.

Card reader 19 includes a slot for receiving identification cards from patients for identification purposes. In this regard, card 29 may be credit card, a driver's license, a dedicated insurance card, a healthcare card, etc., from which, when slipped into the reader 19, information can be read to uniquely identify a patient using the card. To this end, prior to using one of the kiosks to check in for an appointment it is contemplated that patient identities will be associated with patient unique cards in database 72a.

The external terminals 28a and 28b are also similarly constructed and operate in a similar fashion and are described with reference to external terminal 28a. Terminal 28a includes at least a display 21, and a reading device 44 for reading a patient token 42, and can also include an input device 27, a card reader 19 and a printer 17, as described above. The input device 27 can be used, for example, to ask for patient input to verify patient identity in conjunction with reading the token, to allow medical personnel to override the data written to display 21, or to allow medical personnel to enter patient data when a token is not available. Similarly, the card reader 19 can be used to verify patient identification data using a credit card, a driver's license, a dedicated insurance card, a healthcare card, etc.

The examination area internal terminals 30a and 30b are also similarly constructed and operate in a similar fashion and are described with reference to external terminal 30a. Terminal 30a is intended for use by medical personnel in the examination area, and again includes a display 21, an input device 27, and a printer 17, as described above with reference to the kiosk 26a.

Referring again to FIG. 1, database 72a is linked to server 22a and stores programs 13 performed by server 22a and various sub-databases (also referred to as “databases” hereinafter) that may be used by the server software to perform inventive methods. To this end, database 72a can include an electronic medical records database 15 that, as the label implies, stores electronic medical records (EMRs) for facility patients. While EMRs often are extremely detailed, for the purposes of this disclosure portions of the EMR are particularly important. To this end, as shown in FIG. 1, EMR database 15 includes an appointments database 69, a medical orders database 71 and a patient data database 31. Here, while each of these databases are referred to as separate databases in the interest of simplifying this explanation, it should be appreciated that, in at least some cases, each database 69, 71 and 31 may in fact include data interspersed among separate patient EMRs. Thus, for instance, patient information and appointment data for a first exemplary patient Mr. Bruce Johnson may be stored as part of Bruce Johnson's EMR.

Referring now to FIG. 1A, an exemplary patient information database 31 is shown. The patient database includes a patient column 171 that provides patient identification information which can be, as shown here, a name 175 of the patient Bruce Johnson and/or an associated identifier such as a bar code 183, as discussed more fully below. Additional data, such as the social security number 173, address 177, and date of birth 179 can also be provided for identification purposes. Finally, last known vital statistic data, such as a weight 181 of the patient can also be provided. Although an exemplary database is shown here, it will be apparent that various types of patient data can be associated in a database of this type, and that the example is not limiting.

Referring now to FIG. 1B, an exemplary patient appointments database 69 is illustrated which includes a patient column 171 and a schedule section 173. Patient column 171 lists all facility patients including exemplary patients Bruce Johnson 175, and Ava Snead (not labeled). Schedule section 173 includes separate currently scheduled appointments schedule for each patient in column 171. An exemplary schedule for Bruce Johnson is labeled 177 and includes bars 179 and 181 that indicate time slots associated with currently scheduled appointments. Although not shown, database 69 would also store detailed information related to each schedule appointment including resources required, appointment location, information required by the patient prior to the appointment, special pre-appointment patient instruction (e.g., for some lab work and procedures patients need to fast for 12 hours prior to occurrence of the activities, etc.), etc.

Referring now to FIG. 1C, an exemplary medical orders database 71 is shown and includes a patient column 73, an order column 75, and a device set-up column 79. Patient column 73 lists each client of a medical facility. Exemplary clients in column 73, include Bruce Johnson 77. The medical order column 75 lists standing orders for each one of the clients in column 73. For example, for Bruce Johnson 77 in column 73, column 75 lists an order for MRI images to be acquired, and specifies the use of a contrast agent. The device set-up column specifies “standard” parameters, indicating that no specialized acquisition is required. The database can include, however, specific instructions for performing an imaging analysis. The medical orders database 71 can also include various other types of data, such as timing for providing prescriptions to admitted patients, device settings for intravenous fluid delivery, device settings for heart monitoring equipment, and other orders.

Referring now to FIG. 1D, wherein like elements to FIG. 1 are provided with like numbers, in some embodiments, a system 10 can be used in an exemplary health care facility information system 10 that includes, among other components, a server/processor 22, a database 72, a plurality of patient accessible and useable kiosks or interface devices 26a1, 26a2, 26b, 26c, etc., as described above. In at least some embodiments kiosk locations within a facility may be determined automatically either via the actual physical location on network 24 to which the kiosk is linked or via wireless location determining methods where the kiosk includes a wireless transceiver (see 41 in FIG. 1) and wireless access points (see 169a, 169b, etc) are located throughout the facility. Triangulation and other statistical methods for wirelessly determining device location within a facility are well known. Thus, in some embodiments server 22 and the access points may form a wireless location determining system. Here it is contemplated that when a kiosk is moved within the facility, kiosk functionality may change automatically as a function of kiosk location. Thus, for instance, where kiosk 26a1 is at location 25a, kiosk 26a1 may be useable to check in for appointments for either of departments 27a1 or 27a2 but not for department 27c appointments and when kiosk 26a1 is at location 25c, kiosk 26a1 may be usable to check in for department 27c appointments but not for department 27a1 and 27a2 appointments.

Where kiosks 26a1, 26a2, etc., are wireless, in some embodiments it is contemplated that each of the interface devices or kiosks may take the form of a personal digital assistant (PDA) or portable wireless communications device (WCD) or the like that the patient can carry around within the facility or on a providers campus. To this end, the patient 124 can be using a hand held device 30, as shown in FIG. 1D. Here, it is contemplated that location of device 30 can be determined essentially in real time as device 30 is moved about in the facility and location specific check in functions can be facilitated as described above. Moreover, in at least some embodiments, it is contemplated that device 30 may be a patient's own PDA, a cell phone, a Blackberry device, etc. and location specific check in may be facilitated thereby. Prior to using one of the kiosks to check in for an appointment, it is contemplated that patient identities will be associated with patient unique identifiers in database 72.

The system 10 here can further include one or more receptionist/administrator terminal 90. Receptionist/administrator terminal 90 may take any of several forms including a workstation, a personal computer, a thin client, etc. and, in general, includes a display and one or more types of input devices (not labeled, e.g., a keyboard, a mouse controlled cursor). As the label implies, terminal 90 is used by a receptionist in some applications and by a system administrator in other applications.

Database 72 is linked to server 22 and stores programs 74 performed by server 22 and various sub-databases (also referred to as “databases” hereinafter) that may be used by the server software to perform inventive methods. To this end, in addition to the databases and sub-databases discussed above, sub-databases include a patient appointments database 76 and a kiosk functionality database 78. In addition, in at least some inventive embodiment, database 72 can include a way finder database 80 and/or a resource schedule database 82

Referring once again to FIG. 1D, in the present description, in the interest of simplifying this explanation, it will be assumed that system 10 is used within a single large building facility that includes different departments, and that a separate waiting area is provided for each facility department. In FIG. 1, exemplary department waiting areas are identified by labels 27a1, 27a2, 27b, 27c, etc. Hereafter, labels 27a1, 27a2, 27b, 27c, etc., will be used to refer to distinct facility departments. Moreover, it will be assumed that each of the departments will be associated with a specific location or zone within the facility where exemplary locations in FIG. 1 are labeled 25a, 25b, 25c, etc. Thus, in FIG. 1, exemplary departments 27a1 and 27a2 are both associated with location 25a. Similarly, department 27b is associated with location 25b and department 27c is associated with location 25c. Interface devices 26a1, 26a2, 26b, 26c, etc. can be provided at locations throughout the facility, and patients can be guided to specific interface devices or kiosks to check in for appointments at specific facility departments, as described more fully in U.S. Pat. No. 8,768,720 which is incorporated by reference herein in its entirety.

While the system and example described herein is described in the context of a large facility with multiple departments, it should be appreciated that system 10 may be employed in other larger environments including, but not limited to, large health care service provider campuses that include multiple related buildings and larger enterprises where, for instance, an exemplary enterprise may include a plurality of geographically spaced apart campuses or building facilities (e.g., campuses at spaced apart locations in a metropolitan area, within a state, etc.).

Hereafter, in the interest of simplifying this explanation a practical example of the procedure of the present invention is described. In this explanation, it will be assumed that system 10a is located at St. Mary's medical facility where kiosks 26a, 26b, etc., are positioned at various locations throughout the facility, and internal and external examination area displays 28a, 28b and 30a, 30b are provided, respectively, outside and inside of examination area 40a and 40b. It will also be assumed that a patient, Mr. Bruce Johnson, walks up to check-in kiosk 26a to use that kiosk to check-in for at least one scheduled appointment.

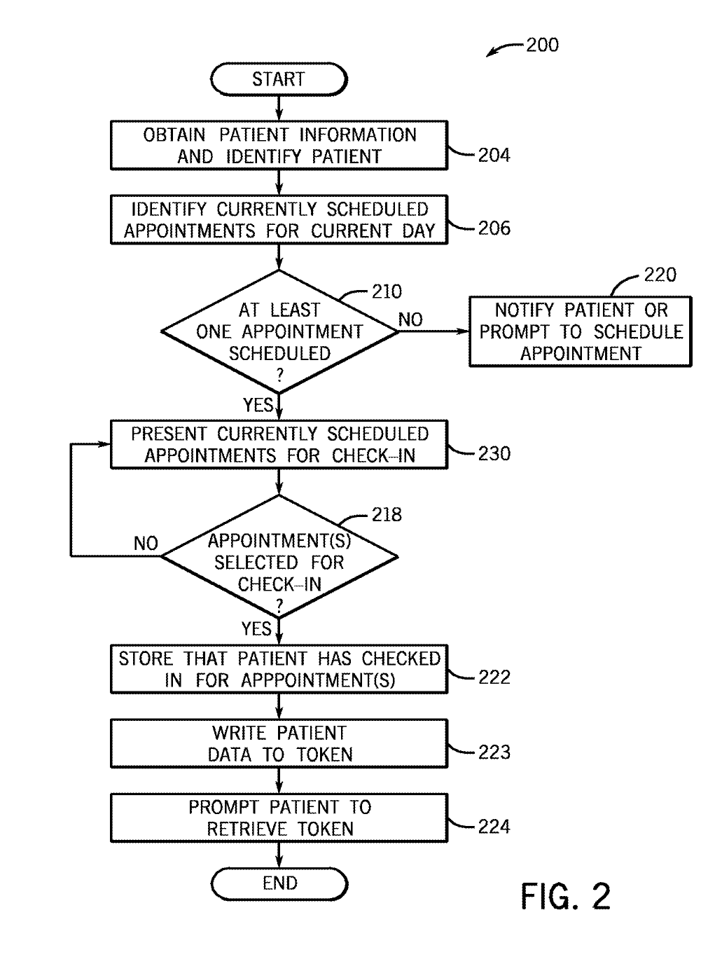

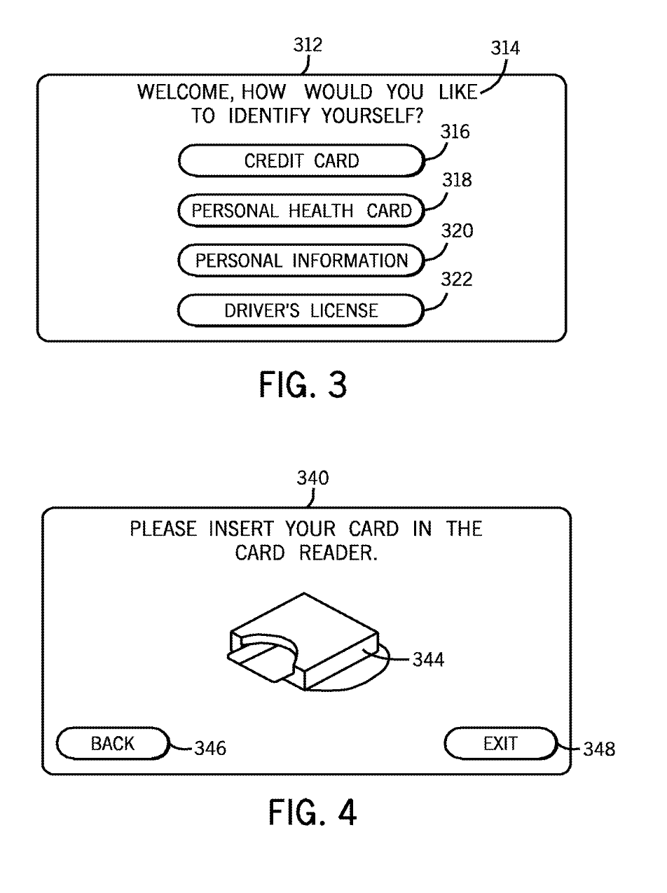

Referring again to FIG. 1 and now also to FIG. 2, a flow chart providing the steps of a check-in process 200 for the patient Mr. Johnson is shown. At block 204, when Mr. Johnson walks up to kiosk 26a to check-in for his appointment, Mr. Johnson is greeted with a greeting screen shot 312 (FIG. 3) which includes instruction 314 near the top of the screen shot and four selectable icons 316, 318, 320, and 322 which can be selected in any of a number of manners well known in the art. The instructions 314 instruct the patient to indicate how the patient would like to identify himself. The selectable icons include a CREDIT CARD icon 316, a PERSONAL HEALTH CARD icon 318, a DRIVER'S LICENSE icon 322, a PERSONAL INFORMATION icon 320. Where PERSONAL INFORMATION icon 320 is selected, the user may enter a user name and password in a manner like that described above to uniquely identify the patient before receiving any information about the patient's currently scheduled appointments or standing orders.

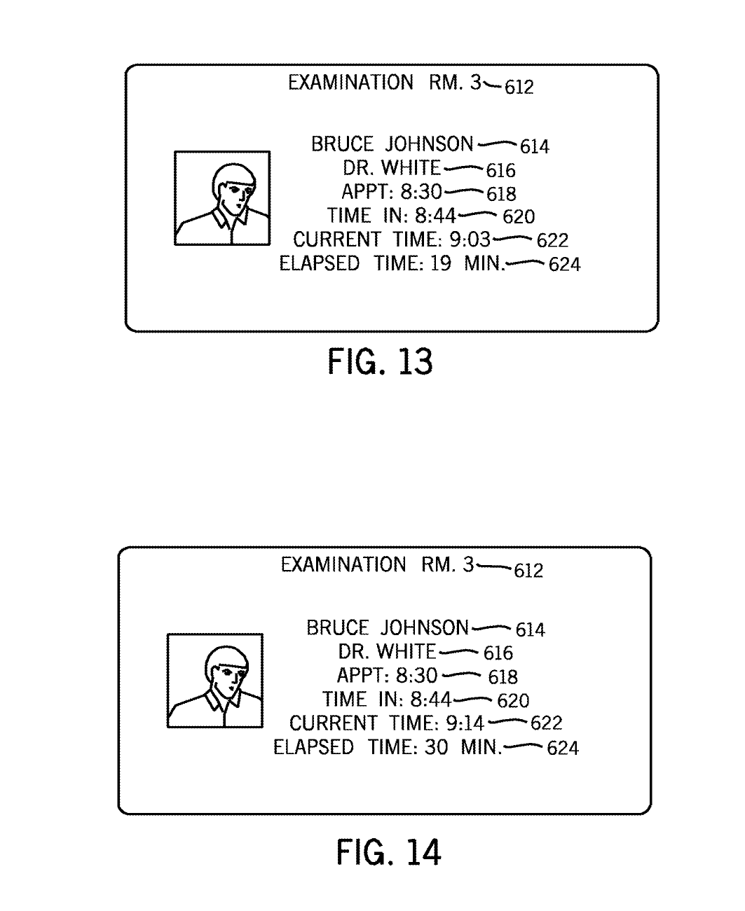

Referring now also to FIG. 4, where any of the card icons 316, 318, 320 or 322 is selected, kiosk 26a provides a screen shot 340 with instructions 342 indicating that the patient should insert his card into the card reader 19. An image 344 of the card reader 19 may be provided to help the user visually identify the card reader. In addition to instructions 342 and image 344, screen shot 340 includes a BACK icon 346 and an EXIT icon 348. BACK icon 346 allows the patient to skip back to screen 312 shown in FIG. 13 to change the way the patient will identify himself. EXIT icon 348 generally allows the patient to exit the check-in procedure. BACK and EXIT icons are provided on all of the screen shots after screen shot 340 and operate in a similar fashion to allow a patient to back up through the screen shots or exit the check-in procedure.

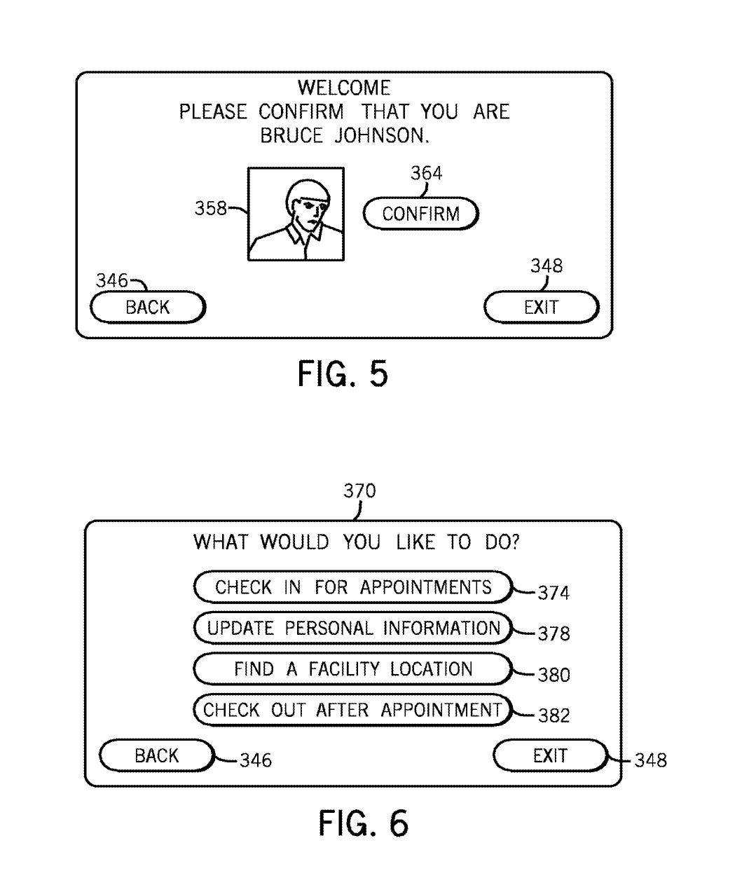

Referring still to FIGS. 1-4 and now also to FIG. 5, after the patient inserts his card into reader 19, at block 204, server 22a obtains patient identifying information from the card. Here, in FIG. 5, the server 22a queries the patient to make sure that the patient is, in fact, Bruce Johnson, and also accesses patient database 31 to cross-check the information against known data. To this end, a picture 358 of the patient stored in a facility database (e.g., in the patient's EMR) may be provided along with a mouse selectable CONFIRM icon 364 to confirm that the server 22a identified the correct patient via the patient's card. Once icon 364 is selected, kiosk 26a provides screen shot 370 (FIG. 6) that includes instructions 372 along with five separate mouse selectable icons that enable the patient to do various things via kiosk 26a. The exemplary icons include a CHECK-IN FOR APPOINTMENTS icon 374, an UP DATE PERSONAL INFORMATION icon 378, a FIND A FACILITY LOCATION icon 380 and a CHECK OUT AFTER APPOINTMENT icon 382. When icon 374 is selected, server 22a facilitates a check-in procedure. When icon 378 is selected, server 22a may step through a procedure that allows the patient to update his personal information stored by server 22a. When icon 380 is selected, server 22a may step through a way finder process to help the patient identify the location of some resource (e.g., a doctor's office, a clinic, an examination room, etc.) within the facility. When icon 382, is selected, kiosk 26a helps the patient step through a check out procedure.

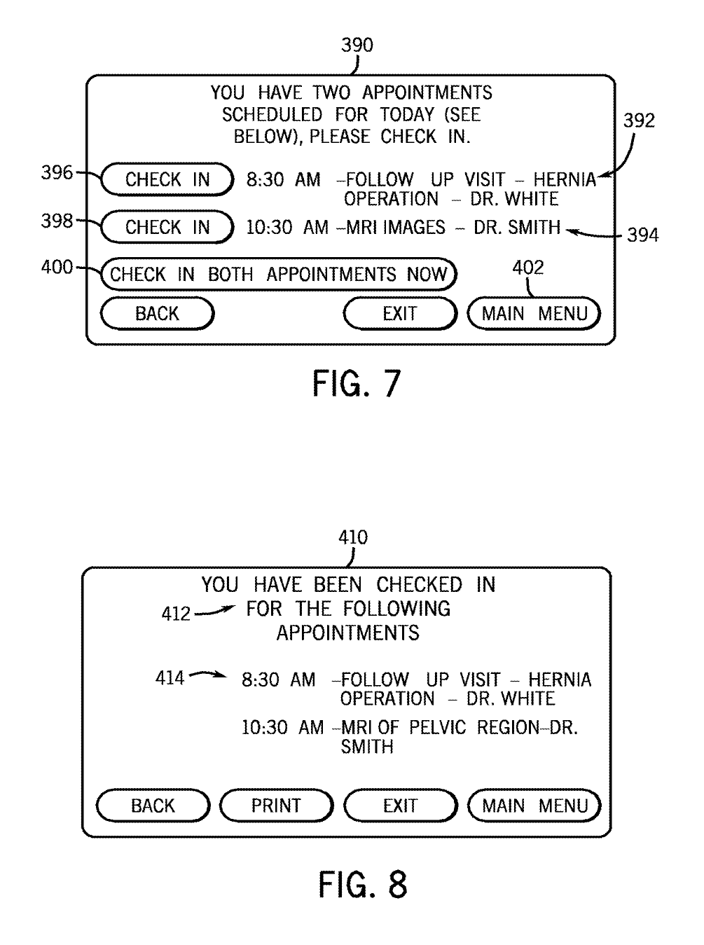

Here, it will be assumed that Mr. Johnson has selected CHECK-IN FOR APPOINTMENTS icon 374. Once icon 374 is selected, server control passes to block 206 in FIG. 2. At block 206, referring again to FIGS. 1 and 2, server 22a accesses appointments database 69 and identifies currently scheduled appointments for the patient for the current day. At block 210, server 22a verifies that Bruce Johnson has scheduled appointments, accesses the appointment database 69 and locates the appointments for the patient. If no appointments exist, the patient is notified and can be prompted to schedule an appointment in block 212. In the present example, there are appointments associated with Bruce Johnson and therefore, at block 230, server 22a presents the currently scheduled appointments for Bruce Johnson so that the patient can check-in. Screen shot 390 (FIG. 7) includes each of the currently scheduled appointments for Bruce Johnson for the day. In addition to listing the appointments, screen shot 390 includes separate CHECK-IN icons 396 and 398 for each of Bruce Johnson's appointments 392 and 394, respectively, that can be independently selected for checking in for the associated appointment. Moreover, screen shot 390 includes a CHECK-IN BOTH APPOINTMENTS NOW icon 400 that can be selected to check-in both the 8:30 a.m. and 10:30 a.m. appointments.

Referring again to FIGS. 1 and 2, at block 218, when the patient selects icon 400 to check-in for both appointments or selects one of the CHECK-IN icons 396 or 398, control passes to block 222 where server 22a stores an indication that the patient has checked in for appointments and may provide notice to a receptionist, nurse, physician, etc. that the patient is present and waiting. In addition, to confirm that check-in has been completed, server 22a generates screen shot 410 shown in FIG. 8 which includes confirming language 412 indicating that the patient has registered. At this time, patient identifying data and appointment data retrieved from the EMR database 15 or the submitted identification is stored to a patient token 42 in block 223. The token 42 can be any of a number of active and passive memory storage or coding devices including, for example, RFID tags, cards including magnetic strips, and bar codes. When the token includes memory storage, a patient identifier can be stored directly to the card. In cases where a code is provided, such as a barcode, the code is associated with the patient identifier in the database 72a to allow for retrieval of the appropriate data later. Referring again to FIG. 1A, in this example, a barcode 183 is associated with the patient Bruce Johnson and can be used for identification purposes. Regardless of the type, the token 42 is preferably provided in a form that can be carried by or worn by the patient, e.g. in a card, wrist band, name tag with associated RFID tag, etc.

Some of these types of tokens, such as the barcode described here, can be provided using a printer 17, as shown in FIG. 1. In other applications, the printer 17 represents a specialized printer, such as an RFID printer, or a bar code or label printing device. Although a printer is shown and described here, it will be apparent that where specialized tokens requiring specialized production equipment are used, the appropriate corresponding production equipment can be connected to the system 10a. Thus, for example, where the token 42 is provided as a card having a magnetic strip, an appropriate writing device can be provided. Furthermore, the data provided on the strip can be encoded in order to limit access to the patient's data in the event that the card is lost or stolen. Additionally, the token 42 can be associated with a random time frame or a time frame selected based on, for example, the date and time of an appointment, the date and time and expected length of a hospital stay. After the selected time has elapsed, the token 42 will expire.

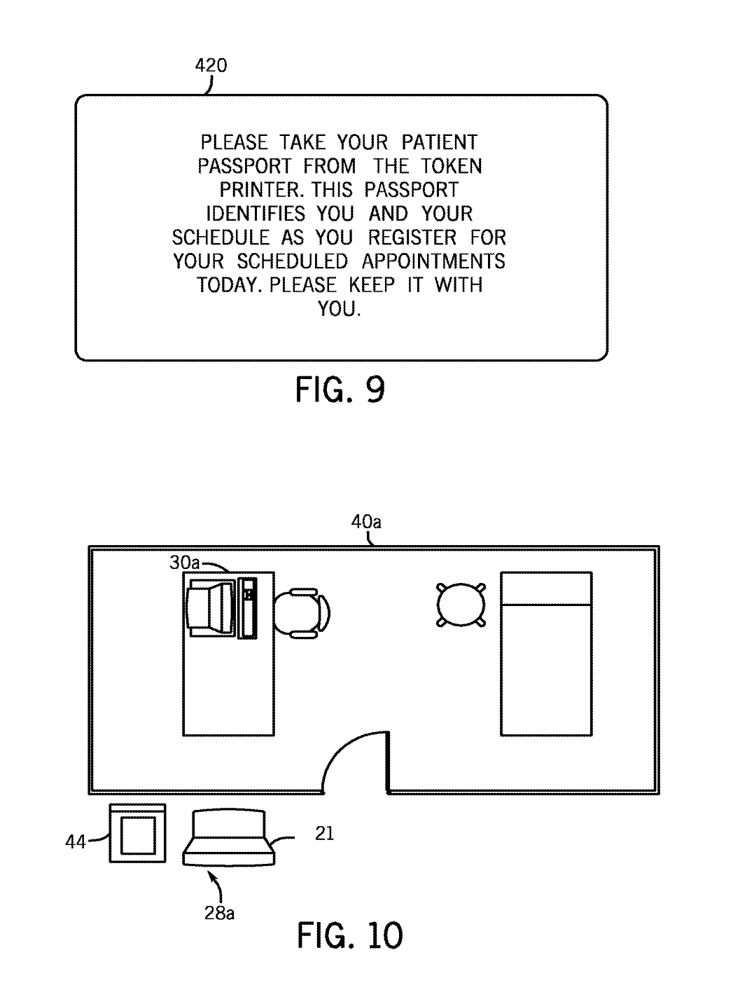

In block 224, the patient is prompted to retrieve the token and to carry the token throughout his or her visit to the facility, as shown in screen shot 420 (FIG. 9). As described above, the token 42 includes a patient identifier that uniquely identifies Mr. Johnson as the patient, and this identifier, therefore, can be used as an index into the database 72a, and particularly the EMR database 15, allowing personnel to access and display data associated with Mr. Johnson during his stay at the medical facility, as described below. In addition to a personal identifier, the data stored to or associated with the token 42 can include Mr. Johnson's address, and picture 358, and other personal data. An appointment schedule, and the names or other identification of health care personnel assigned either to the patient or to an examination area associated with Mr. Johnson's appointment can also be stored in the token 42. The additional data can be provided to limit the need for access to the server 22a, and can also limit the need to link the external examination terminals 28a to the server 22a. In some applications of the present invention, therefore, the terminals 28a could be linked directly to the corresponding terminals 30a, rather than to the server as shown in FIG. 1.

Referring now to FIG. 10, as Mr. Johnson moves to an examination area 40a for his first appointment, an external terminal 28a is provided outside of the examination area and a corresponding internal terminal 30a is provided inside of the area 40a. The external terminal 28a can, as shown here, include a display and a reader device 44 for reading a token 42 presented by Mr. Johnson. While a reader or scanning device 44 is shown here, in some applications, such as an RFID tag, the tag associated with Mr. Johnson will be read automatically as he enters the examination area 40a. The appropriate reading equipment, therefore will vary by application, and the card reader shown here is exemplary.

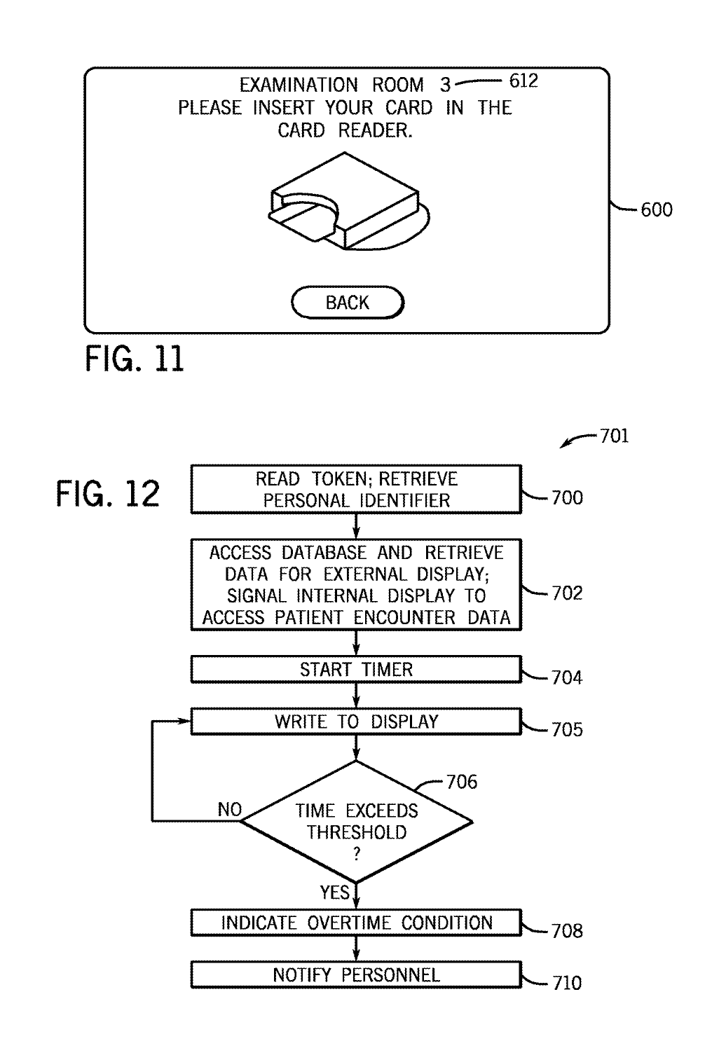

Referring now to FIGS. 11 and 12, when Mr. Johnson arrives at an examination area 40a, a process 701 for tracking the patient in the examination area 40a is started by server 22a. At process block 700, Mr. Johnson, or an accompanying medical staff member, is prompted by screen shot 600 (FIG. 11) to swipe the token 42 through the reader 44. After the token 42 is read, at process block 702, data related to the patient is accessed in the patient database 72a, and patient data is retrieved from the patient database 31, along with appointment data from database 69. The patient identifier is also provided to the terminal 30a, which accesses database 72a to retrieve patient encounter data for the identified patient, Mr. Johnson. At process block 704, a timer is also started to calculate the elapsed time that Mr. Johnson has been in the examination area 40a, and in process block 705, patient data is written to the display 21 associated with terminal 28a outside of the examination area 40a. Referring now to FIG. 13, the display 21 can provide an examination area identifier 612, patient name identifier 614, and a scheduled appointment time 618. To track the progress of the patient in the examination area 40a, a check-in time in 620, a current time 622, and an elapsed time 624 can all be displayed on the display 21. Although the data is shown here as displayed directly outside the examination area, the display may also be provided at a central location such as a nurse's station, reception area, physician office area, or in other areas within or outside of the facility. A centralized display may be provided either in place of or in addition to the examination area display, and may provide data for a number of different examination areas serviced by the centralized location. The display may also be transmitted to and be accessible to associated medical personnel through personal computing devices, pagers, blackberry devices, cellular telephones, and other personal communication and computing devices with access to the server 22a.

Referring again to FIG. 12, after Mr. Johnson enters the examination area 40a, the timer begins to count up. As the time increases, the current elapsed time is continually written to the display 21 and is compared to a predetermined threshold in process block 706. When the timer value exceeds the established threshold, an over time condition occurs, and, in process block 708, an over time indicator is written to the display 21 on terminal 28. Referring now to FIG. 14, the over time condition is here shown by italicizing the font of the elapsed time block 624. The over time condition, however, can be displayed by changing the color of the text, by causing the data on the display 28 to blink, or by printing a separate text message on the display, either in place of the existing text or in addition to the existing text. In addition, or as an alternative to providing an indicator on the display, in process block 710, medical personnel associated with Mr. Johnson's appointment are notified by electronic means. The notification can be made through wireless handheld device 743 (FIG. 1) by paging the personnel, or by forwarding a text message, an email message, or a fax, or through a telephone or cellular call. Various other wired or wireless devices can also be used to provide notices or alarms to the associated medical personnel, as will be apparent to those of skill in the art.

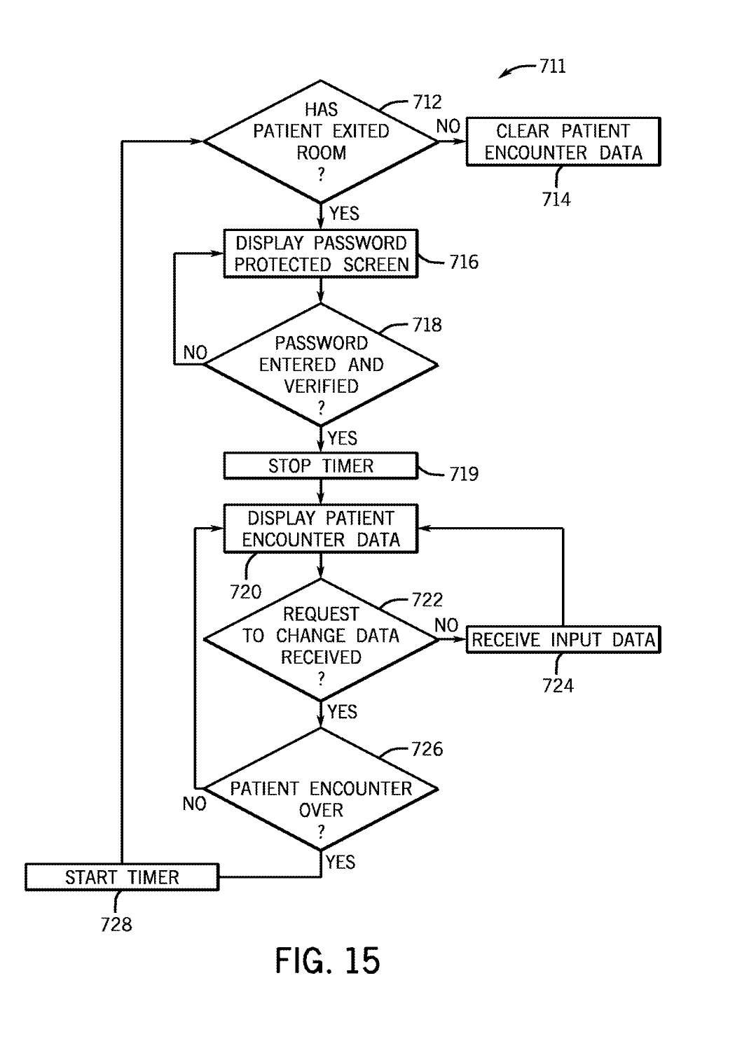

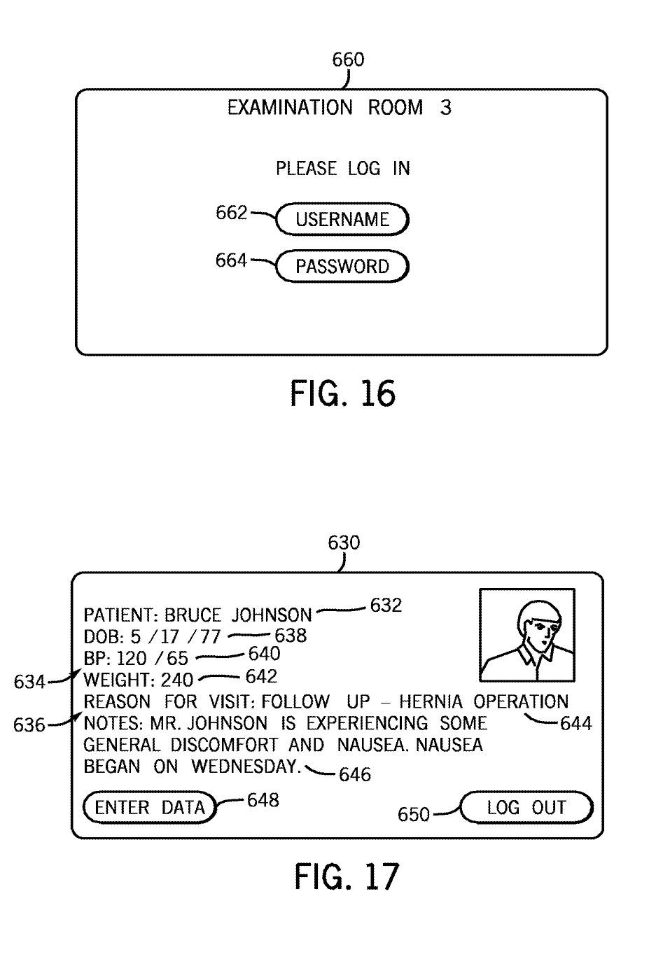

Referring now to FIG. 15, the process 711 for providing patient encounter data inside of the examination area 40a is shown. After Mr. Johnson enters the examination area 40a, in process block 712, the server 22a continually monitors signals from the reader 44 to verify that Mr. Johnson remains in the room. While the patient remains alone in the room, a password protected screen is displayed, as shown in process block 716, and screen shot 660 of FIG. 16. This protected screen is displayed until medical personnel enters the room, enters a valid username 662 and password 664, and has the password verified in process block 718. The password screen 660 can be programmed to accept a password from any medical personnel associated with the facility, or to accept only password identification associated with the personnel assigned to the examination area 40a, or the identified patient. When the password is verified, in process block 719, the timer is stopped, as medical personnel have entered the room and started the appointment, and timing the delay is no longer necessary. In place of the elapsed timer on the display 21 of external terminal 28a, the display can provide a do not disturb message or other indicator that an examination is in process. In place of the password screen, patient encounter data screen 630 for the scheduled appointment is provided on the display 21 of the internal examination area terminal 30a. The patient encounter data screen 630 is automatically displayed and includes data specific for the scheduled appointment.

Referring now also to FIG. 17, an exemplary patient encounter screen 630 is shown. The patient encounter screen 630 includes a patient name identifier 632, a patient picture 358, vital statistic data 634, and medical notes 636. The vital statistic data 634 can include, as shown here, a date of birth 638, a blood pressure 640, and a weight 642 of the patient, Mr. Johnson. The medical notes 636 can include a reason for the visit 644 and any associated notes 646 that were acquired either from the patient at a kiosk 26a, by the receptionist, when a call was made to make the appointment, or at other times prior to the appointment. The screen 630 also includes an INPUT DATA icon 648, and a LOG OUT icon 650. Although exemplary patient encounter data is shown here, the “patient encounter data” can be any type of patient-related and procedure-related data appropriate to a given medical facility, examination area, medical procedure, etc., and the description here is not intended to be limiting.

Referring again to FIG. 15, in process block 722, after the patient encounter screen 630 is accessed, medical personnel can select the INPUT DATA icon 648 to choose to correct or add data for the patient encounter. Thus, for example, a nurse may initially enter the examination area 40a, take a blood pressure reading for Mr. Johnson, select the INPUT DATA icon 648, select the blood pressure block 640 with a mouse or other input device, and enter the acquired data. The data can be written both to screen 630 and to the database 72a in process block 724. After the data is entered, the process 711 returns to the display 720 and waits for the medical personnel to either enter more data through data entry button 648, or to log out using LOG OUT icon 650. When the examination is complete the medical personnel leaves the examination room by logging out in process block 726. When the medical personnel leaves the examination area 40a, patient delay again becomes an issue, and the timer can be restarted in process block 728. After the timer is started, the process 711 returns to block 712.

At block 712, process 711 again verifies that Mr. Johnson has completed his appointment and left the examination area, here by verifying that a card swipe has not been detected in card reader 44. If the patient is still in the examination area 40a, the password protected screen 660 is returned to the display 21 (process block 716). When another medical staff member enters, such as a physician, the physician again enters a username 662 and password 664. The patient encounter screen 630 is returned to the display. When the patient has completed the examination, the patient again swipes his card in the card reader 44. In process block 712, the process 711 determines that the patient has completed the examination, and clears the patient encounter data from the display 21 in process block 714. After the patient leaves the area, the “insert card” screen of FIG. 11 can be returned to display 21 on terminal 28a, prompting the next patient to insert his or her card. Alternatively, the display 21 can indicate that the examination area is vacant. The external display can also be used to provide instructions to the exiting patient. Thus, for example, Mr. Johnson could be provided with a map directing him either to his next appointment, or to the lobby, or to a kiosk 26a to schedule another appointment or enter payment. In the specific example shown here, Mr. Johnson can be directed to an MRI examination area 40b for his 10:30 appointment.

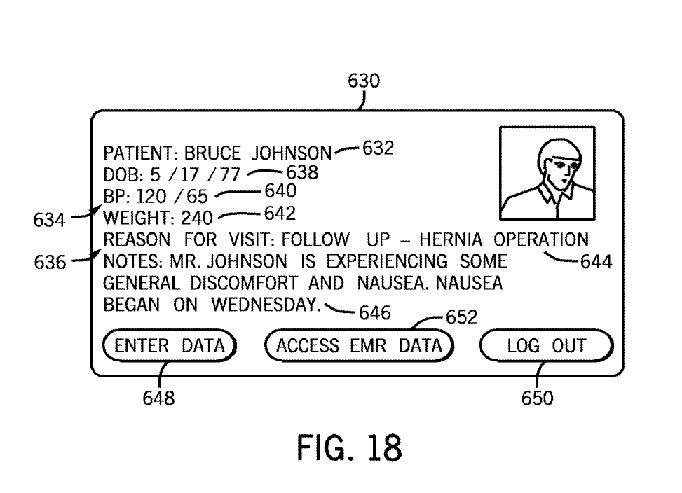

Although, as described above, a single patient encounter display 630 is provided to all medical personnel that log into the terminal 30a, it will be apparent that varying levels of detail may be provided to different medical personnel, and that the appropriate level of display can be changed based on the password entered. Referring now to FIG. 18, for example, a physician may be allowed access to additional data in the EMR database 15 through an additional icon selection 652 allowing access to additional EMR data. Furthermore, although an elapsed time that the patient is left alone in the examination area 40a is described above, it will be apparent that the overall time between patient entry and examination by a physician could be determined, and further, that the overall time that the patient is in the examination area 40a could also be calculated. This data could be analyzed to improve efficiency in care services. Furthermore, levels of delay, for example, time to arrival of nurse, time to arrival of physician, and overall time, could all be logged and stored for later analysis. This data could also be used to provide an “expected delay” message to patients checking in at the kiosk system 26a, 26b, 26c, or to a receptionist or other personnel.

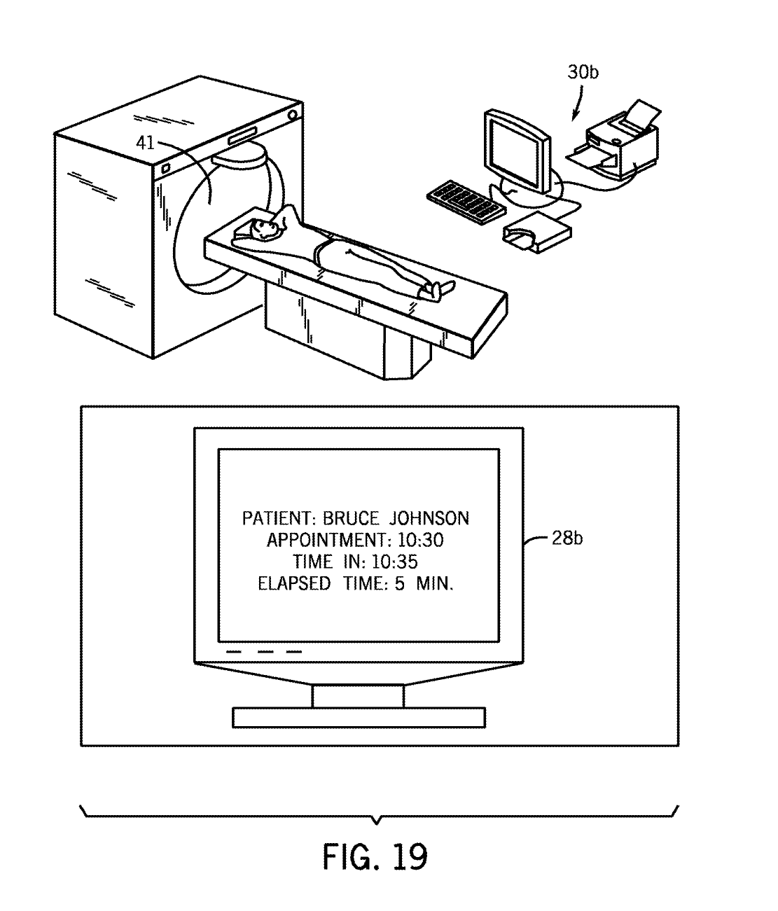

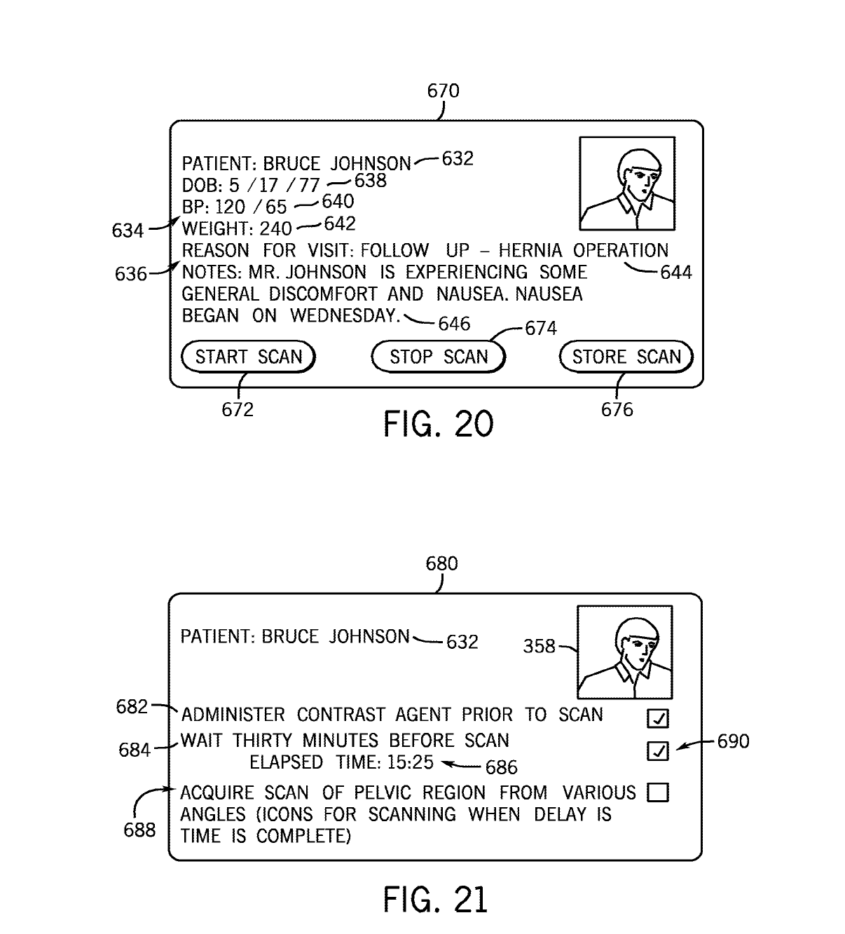

Although the system has been described above as used specifically in an examination room setting, the patient flow management system 10a can also be used in other health care facility and clinical settings. Referring now to FIG. 19, an example of the use of the patient flow system of the present invention in a radiology department is shown, as Mr. Johnson continues to his 10:30 appointment. Here, the external terminal 28b provided on a wall outside of an MRI examination area 40b, and displays patient name, appointment data, etc. as described above. An internal terminal 30b is provided in the examination area 40b. The MRI machine 41, external terminal 28b, and internal terminal 30b are all connected to the server 22a, which can control the MRI machine. When the patient Mr. Bruce Johnson enters the examination area 40b, his token 42 is scanned or otherwise read. The system retrieves appropriate MRI machine settings from the medical orders database 71, and accesses a mapping table 43 (FIG. 1) that correlates the required action to a DICOM, HL7 interface, api interface or custom code associating executable code with the MRI machine to provide the selected function. When the MRI machine 41 is ready to scan, a START SCAN icon 672, a STOP SCAN icon 74, and a STORE SCAN icon 676 are displayed, and are correlated with software for the appropriate function on the MRI machine 41. Medical personnel in the examination area 40b determine the appropriate views based on the notes provided on the display 670, acquire and store the appropriate images using the icons 672, 674, and 676. The images can be stored directly to the database 72a, or to a predetermined image database.

Referring now to FIG. 21, an alternate screen shot 680 illustrating an application in which a series of steps are required in a patient encounter is shown. Here, the series of steps are provided in a check list 690 that allows the user to “check off” as the steps are completed. Initially, the patient encounter screen 680 provides an instruction to administer a contrast agent 682, along with an associated check box. After the contrast agent is administered, the screen shot 680 provides an instruction to wait for thirty minutes, and provides an elapsed time counter 684. Finally, an instruction to acquire images 688 is provided, again with an associated check box. Therefore, as processes are completed, the medical personnel can “check off” the steps. Where timing is required, as shown here, the check box can be automatically written to the screen when the elapsed time is over. In some applications, the subsequent steps can be hidden until the displayed step is competed, therefore providing the subsequent step only after the current step is completed.

Therefore, through use of the patient flow system described above, it is possible to greatly increase the efficiency of a health care facility, reduce errors, and improve patient satisfaction. As Mr. Bruce Johnson moves through his day as described above, he is specifically identified at each examination area, so that medical personnel can be assured that data associated with Mr. Johnson is the correct data. At each examination area, moreover, the system prepares for the appropriate medical procedure or examination, and these examinations are automatically set up at each stop along the way. The system can also assure that Mr. Johnson is not left or forgotten in an examination room. The system can also simplify patient check in, assure that the appropriate medical personnel see Mr. Johnson, verify that the appropriate medical history data is associated with Mr. Johnson, and otherwise improve patient care.

Although the invention has been generally described above for out-patient services, the application of the present invention can also be used when a patient is admitted to a facility. Thus, for example, an external terminal 28a could be provided outside of a hospital room or surgical area, and a corresponding internal terminal 30a within the area. Instead of defined terminals, moreover, communication to physicians could also be provided through hand-held computing devices and phone services. Here, as patients move between their room and other departments for analysis and testing, the patient token 42 is used to identify the patient, set up patient encounter data, and to complete the appropriate testing. When the patient is returned to his or her room, on-going care schedules can be established, including drug regimens, intravenous fluid systems, and monitoring systems. Furthermore, temperature settings, radio and television stations, and other “environmental” factors can be set up within the patient's room to provide a more comfortable environment.

Furthermore, although the patient identification described above is a token, it will be apparent that a credit card, insurance card, or driver's license could also be used to check patients into various examination areas, identify the patient, and set up patient encounters and patient encounter data, as described above with respect to the kiosk. Additionally, tokens and other types of identification can also be used by medical personnel to log into and examination room terminal, in lieu of the password system described above. Biometric forms of identification, including fingerprints, retinal scans, DNA analysis, etc. can be used both by patients and medical personnel.

Additionally, while the system has been described above to include an automated check-in system, in alternative embodiments, patient check-in can also be done through a receptionist. To this end, referring again to FIG. 6, an exemplary receptionist terminal 950 is shown linked to network 24a where the terminal 950 has components similar to the components described above in the context of kiosk 26a. As in the case of the patient kiosk, here it is contemplated that a simplified check-in/scheduling interface would be provided to a receptionist that makes it extremely easy for a receptionist to identify schedule optimizing options and to modify a patients schedule when desired.

One or more specific embodiments of the present invention have been described above. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Thus, the invention is to cover all modifications, equivalents, and alternatives falling within the spirit and scope of the invention as defined by the following appended claims. For example, while system 10 in FIG. 1 is shown as having a single receptionist/administrator terminal 950, in some embodiments multiple terminals 950 may be provided. Furthermore, the number if kiosks 26a, 26b, and 26c, and examination room terminals 28a, 28b, 30a, and 30b, is exemplary and is not intended to be limiting. To apprise the public of the scope of this invention, the following claims are made:

I claim:

1. A patient flow management system comprising:
a central computing system;
a database in communication with the central computing system and storing patient identification data, appointment data, appointment location data, and medical order data; and
a plurality of reader devices in communication with the central computing system, each of the plurality of reader devices being located external to and adjacent a corresponding examination area and programmed to read a patient identifier coupled to a patient;
an external display in communication with the central computing system provided external and adjacent to each corresponding examination area and reader device; and
an internal display in communication with the central computing system provided inside each corresponding examination area,
wherein when a patient enters a selected examination area, the central computer system is programmed to retrieve the patient identifier data from the reader, retrieve data from the patient database based on the patient identifier to identify a scheduled activity for the patient and a location of the scheduled activity, identify a location of the patient, determines whether the patient can check in for the scheduled activity at the current location, and, when the patient is in the correct location, checks the patient in, writes patient identifying data on the external display adjacent to the examination area, prepares a security protected medical encounter for medical personnel on the internal display in the examination area based on the patient identifier to be accessed when a medical practitioner enters the examination area to examine the patient, and monitors signals from the reader device to assure the patient remains in the examination area, wherein when a medical practitioner enters the examination room the medical practitioner can ascertain the identity of the patient in the examination area, and when the medical practitioner enters a practitioner identifier at the internal display the medical practitioner accesses the patient medical encounter of the patient is in the examination area.

2. The system of claim 1, wherein the patient identifier is a wireless communication device (WCD), and the WCD is in communication with the central computing system through a wireless communications network.

3. The system of claim 1, wherein the wireless communications network comprises a plurality of wireless access points, and the processor is programmed to identify the location of the WCD by triangulation.

4. The system of claim 1, wherein the step of preparing for a patient encounter comprises displaying a check list of patient activities for medical personnel.

5. The system of claim 1, wherein the central computing system is further programmed to secure access to the internal display by requiring at least one of a password, a token, or a biological identifier to access patient data.

6. The system of claim 1, wherein the central computing system is further programmed to start a timer when the patient enters the examination area and calculating at least one of a time until a medical practitioner examines the patient and a total time the patient is in the examination area.

7. The system of claim 1, wherein the central computing system is further programmed to assign a patient identifier by assigning at least one of an active and a passive memory storage device to the patient and storing patient identifying data on the memory storage device.

8. The system of claim 1, wherein the central computing system is further programmed to assign a patient identifier comprises assigning at least one of an RFID tag, a bar code, and a card including a memory storage element to a patient.

9. The system of claim 1, wherein the central computing system is further programmed to identify medical personnel assigned to the patient on the external display.

10. The system of claim 1, wherein the central computing system is further programmed to display an elapsed time on the external display, the elapsed time providing an indication of the period of time that the patient has been in the examination area.

11. The system of claim 10, wherein the central computing system is further programmed to determine a period of time that the patient has been in the examination area and to notify medical personnel if the patient has been in the examination area for a period of time greater than a predetermined threshold time period.

12. The system of claim 1, wherein the central computing system is further in communication with a kiosk, and the central computing system is further programmed to issue a token including the patient identifier at the kiosk.

13. The system of claim 1, wherein the central computing system is further programmed to display at least one of a patient name, a patient vital statistic, a reason for a patient visit, and an icon for controlling a medical device on a display in the examination area.

14. The system of claim 1, further comprising a display in communication with the central computing system corresponding to each examination area.

15. The system of claim 1, further comprising a medical device for providing a medical procedure for a patient, the medical device being in communication with the central computing system, wherein when a patient identifier is read by the reader in the examination area, the central computer system retrieves a patient medical order from the database, prepares for the patient encounter using the patient data and the patient work order, and controls a medical device to provide a procedure associated with the encounter.

16. The patient flow management system as recited in claim 1, wherein the central computer is programmed to access a mapping table that correlates an action associated with the patient work order to a correlating code associated with the medical device.

17. A patient flow management system for managing the flow of a patient through a medical facility, wherein the patient is identified by a patient identifier coupled to the patient, the system comprising:
a central computing system in communication with a database storing patient identification data, appointment data, appointment location data, and medical order data; and
a plurality of wireless access points in communication with the central computing system through a wireless communication system;
an external display in communication with the central computing system provided external and adjacent to each corresponding examination area; and
an internal display in communication with the central computing system provided inside each corresponding examination area,
wherein the central computing system is determine the position of the patient through triangulation, and, when a patient enters a selected examination area, the central computer system is programmed to retrieve the patient identifier data from the reader, retrieve data from the patient database based on the patient identifier to identify a scheduled activity for the patient and a location of the scheduled activity, identify a location of the patient, determine whether the patient can check in for the scheduled activity at the current location, and, when the patient is in the correct location, checks the patient in, writes patient identifying data on the external display adjacent to the examination area, prepares a security protected medical encounter for medical personnel on the internal display in the examination area based on the patient identifier to be accessed when a medical practitioner enters the examination area to examine the patient, and monitors signals from the reader device to assure the patient remains in the examination area, wherein when a medical practitioner enters the examination room the medical practitioner can ascertain the identity of the patient in the examination area, and when the medical practitioner enters a practitioner identifier at the internal display the medical practitioner accesses the patient medical encounter of the patient is in the examination area.

18. The patient flow management system of claim 17, wherein the patient identifier comprises a wireless communications device (WCD).

19. The patient flow management system of claim 18, wherein the central computing system is further programmed to calculate a travel time for the patient between location of the WCD and the location of the scheduled activity.

20. The patient flow management system of claim 18, wherein the central computing system is further programmed to calculate a travel time for the patient between a location of the WCD and the location of the scheduled activity.
